(19) United States
(12) Patent Application Publication
(10) Pub. No.: US 2005/0252739 A1
(43) Pub. Date: Nov. 17, 2005

(54) METHOD OF MAKING BRAKE DISCS AND ROTORS WITH OPEN SLOTS AND BRAKE DISCS AND ROTORS MADE THEREWITH

(76) Inventors: Fred J. Callahan, Statesville, NC (US); George E. Talia, Wichita, KS (US)

Correspondence Address: SIMPSON & SIMPSON, PLLC, 5555 MAIN STREET, WILLIAMSVILLE, NY, 14221-5406, US

(21) Appl. No.: 10/709,533

(22) Filed: May 12, 2004

(51) Int. Cl. F16D 55/02

(52) U.S. Cl. 188/218 XL; 188/18 A

(57) ABSTRACT

The present invention broadly comprises a brake disc having superior cooling characteristics and a method for manufacturing brake discs with superior cooling characteristics. The brake disc has at least one slot arranged at an angle greater than zero degrees and less than ninety degrees with respect to a radius of said disc passing through said slot. The angle can be selected to enhance cooling under specified conditions. Slots in the disc can open to an inner or outer perimeter of the disc or may be fully enclosed within the disc. The shape and width of the slots and the spacing between the slots can be selected to enhance cooling properties of the disc.

### FIELD OF THE INVENTION

This invention relates to the manufacture of brake discs and rotors. More specifically it relates to manufacturing a brake disc or rotor with superior cooling characteristics. Even more particularly, it relates to a method for making brake discs and rotors with open slots and brake discs and rotors made therewith.

### BACKGROUND OF THE INVENTION

A disc brake system comprises a brake disc or rotor (hereinafter “disc”0 connected to a wheel of a vehicle. The disc rotates with the wheel while the vehicle is moving. To slow the vehicle, brake pads are actuated to contact the disc. The brake pads are connected to brake calipers, which are mounted within the vehicle. The brake calipers move the pad towards the disc during braking, causing the pad to contact the disc. The frictional force between the pad and disc slows the rotation of the wheel, in part, by converting kinetic energy from the wheel motion to heat. The heat generated by the frictional contact can dramatically increase the temperature of the pad and disc, resulting in undesirable geometrical changes in the disc, such as cupping or dishing or the formation of “heat cracks” in the disc. The aforementioned geometrical changes and heat cracks can reduce the strength and durability of the disc and, under severe braking conditions, may lead to disc failure.

One potential cause of failure of a heated brake disc is the expansion of the disc due to the temperature increase. It is known in the art that radial slots in a brake disc can help reduce the stress within the disc due to temperature expansion. For example, U.S. Pat. Nos. 2,850,118 (Byers), 2,987,143 (Culbertson et al.), 3,425,524 (Dewar), and 5,850,895 (Evrard) disclose brake discs having slots to minimize failure of the member due to thermal induced stresses. These slots are positioned parallel to or orthogonal to a radius for the disc. However, these references do not address the underlying problem of reducing the heat generation, which is the cause of the thermal stresses. Hereinafter, unless noted otherwise, slot angle magnitude is referenced with respect to a disc radius passing through the slot. Therefore, a low slot angle references a slot more nearly parallel to the radius and a high slot angle references a slot more nearly orthogonal to the radius. In fact, excessively low slot angles, such as those associated with a radial slot, may cause undesirable flow separation, which results in pockets of air having low velocity, that is, providing minimal heat removal, while causing significant drag.

Clearly, there is a longfelt need for a brake disc that has enhanced cooling characteristics to prevent failure under severe braking conditions.

### SUMMARY OF THE INVENTION

The present invention broadly comprises a method for manufacturing brake discs with slots therein and discs made therewith. The brake disc has at least one slot arranged at an angle greater than zero degrees and less than ninety degrees with respect to a radius of said disc passing through said slot. The angle can be selected to enhance cooling under specified conditions. Slots in the disc can open to an inner or outer perimeter of the disc or may be fully enclosed within the disc. The shape and width of the slots and the spacing between the slots can be selected to enhance cooling properties of the disc.

A general object of the present invention is to provide a brake disc, and a method to fabricate such brake disc, with superior cooling characteristics.

Another object of the present invention is to provide a brake disc, and a method to fabricate such brake disc, that can endure severe braking conditions without failure due to thermal stresses.

A further object of the present invention is to provide a brake disc, and a method to fabricate such brake disc, displaying minimal distortion during high temperature operations.

It is yet another object of the present invention to provide a brake disc, and a method to fabricate such brake disc, displaying minimal hoop stress formation during braking operations.

It is a still further object of the present invention to provide a brake disc, and a method to fabricate such brake disc, displaying an optimal combination of laminar and turbulent cooling.

This and other objects, features and advantages of the present invention will become readily apparent to those having ordinary skill in the art upon a reading of the following detailed description of the invention in view of the drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1A is a front view of a present invention brake disc having a plurality of slots arranged for low speed cooling in a hybrid open-close slot pattern (HOSP);

FIG. 1B is a side view of the disc in FIG. 1A;

FIG. 2 is a front view of a present invention brake disc having a plurality of slots arranged for high speed cooling in an OSP;

FIG. 3 is a partial front view of a wedge-shaped mounting hole in a present invention brake disc;

FIG. 4A is a partial front view of a present invention brake disc with a plurality of slots arranged for low speed cooling in a HOSP and having protrusions to keep slots open;

FIG. 4B is a partial front view of a present invention brake disc with a plurality of slots arranged for high speed cooling in a HOSP and having protrusions to keep slots open;

FIG. 5 is a partial front view of a present invention brake disc with a curved slot; and,

FIG. 6 is a partial plan view of a slot from FIG. 1A.

### DETAILED DESCRIPTION OF THE PREFERRED EMBODIMENT

It should be appreciated that in the detailed description of the invention that follows, like reference numbers on different drawing views are intended to identify identical structural elements of the invention in the respective views. In the present specification the term “disc” is used to refer to an article of manufacture also known as a “rotor.” Both brake discs and rotors are within the spirit and scope of the invention as claimed.

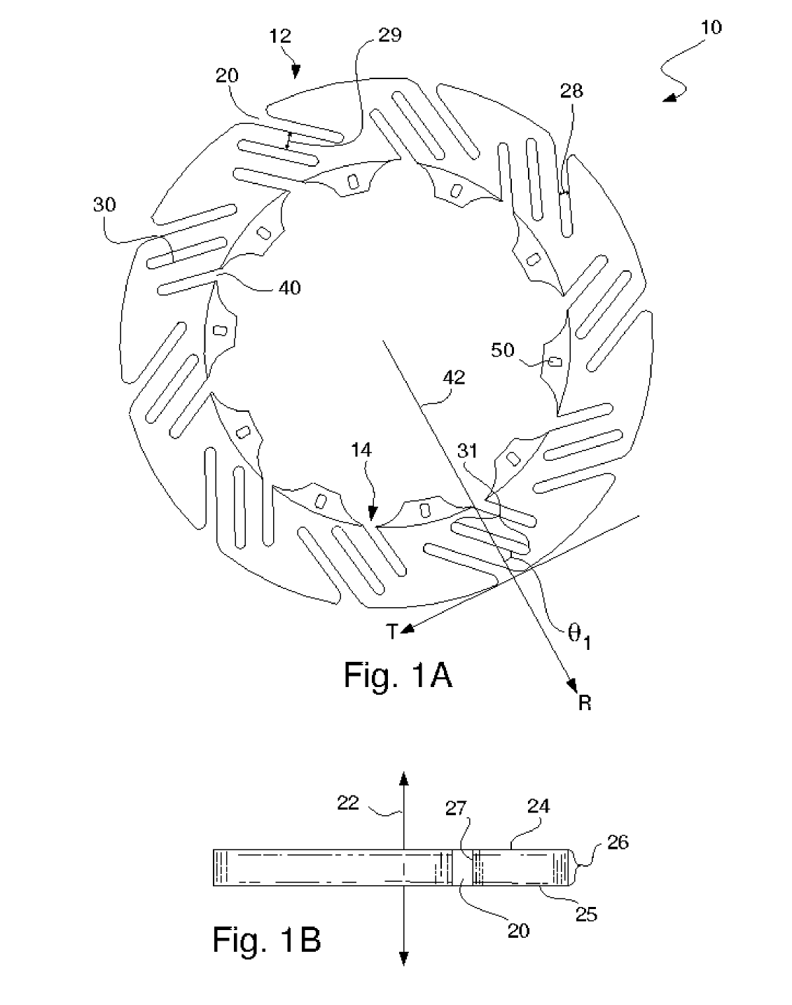

FIG. 1A is a front view of a present invention brake disc 10 having a plurality of slots arranged for low speed cooling in a hybrid open-close slot pattern (HOSP). Disc 10 has an outer perimeter 12 and an inner perimeter 14. Disc 10 includes slots 20, 30, and 40. Mounting holes 50 receive a fastener (not shown) to connect disc 10 to a brake assembly (not shown). In the embodiment shown in FIG. 1A, slots 20 extend to the outer perimeter 12, slots 30 are fully enclosed within disc 10, and slots 40 extend to the inner perimeter 14. In general, slots can be open to a perimeter of a disc, and are therefore referred to as open slots, or can be fully enclosed by a disc, and are therefore referred to as closed slots. Slots 20 and 40 are examples of open slots and slots 30 are examples of closed slots. Combinations including only open slots are referred to as open slot patterns (OSPs). Combinations including both open and closed slots are referred to as HOSPs.

It should be understood that FIG. 1A shows only one possible configuration of slots 20, 30, and 40. Disc 10 can be fabricated to include only slots 20, only slots 40, only slots 30, or other combinations such as slots 20 and 40, slots 20 and 30, or slots 30 and 40. This same range of possible slot configurations also is applicable to other embodiments of the present invention.

FIG. 1B is a side view of the disc 10 in FIG. 1A. The following should be viewed in light of FIGS. 1A and 1B. Disc 10 has axis of symmetry 22, face surface 24, face surface 25, and thickness 26. Face surfaces 24 and 25 are substantially orthogonal to axis 22. Slot surface 27, is bounded by face surfaces 24 and 25. Slot surface 27 is shown for a slot 20, however, it should be understood that slot surfaces for all slots in the present invention are formed between the face surfaces of the disc. Slot surface 27 is substantially parallel to axis 22. However, it should be understood that different orientations of slot surfaces are possible and that such orientations are within the spirit and scope of the invention as claimed. For example, a slot surface could be slanted at a specified acute angle with respect to axis 22. Also, the orientation of a slot surface need not be uniform throughout a slot. For example, in a single slot, portions of the slot surface could be parallel to axis 22 and other portions could be an acute angle with respect to axis 22.

A key element of the present invention is the shaping and positioning of slots in a brake disc so as to improve the heat transport characteristics of the disc and to thereby minimize the problems, noted supra, associated with elevated temperatures in the disc. The above shaping and positioning is designed to increase the overall volume of airflow across the disc and to provide the optimal ratio of turbulent and laminar airflow across and through the disc. Turbulent airflow is associated with the random fluctuations of a fluid in movement and is characterized by eddies and vortices. The velocity gradient at the surface of the disc is much greater for turbulent airflow, which increases the heat transfer rates. However, increased drag on a brake disc is associated with an increase in turbulent airflow over the disc.

In previous disc designs, most airflow around a brake disc is laminar. That is, the speed of the airflow varies layer-by-layer. The speed of the layers decreases uniformly from the layer furthest from the disc to the layer closest the disc. In fact, the closest layer has a speed of nearly zero. In addition, for a fluid, such as air, heat removal depends on the relative velocity between the disc and the fluid layers. Thus, laminar airflow has limited effectiveness for heat removal since the layers closest to the disc brake have the least capability to remove heat from the disc.

Both laminar and turbulent airflow are affected by the shape and positioning of the present invention slots. Laminar airflow is discussed first. Detached spaces in which laminar airflow and heat transfer are minimized form at the inlet and outlet of a hole or slot. Therefore, it is desirable to increase the length of a hole or slot with respect to the direction of airflow. Slots are inherently superior to holes, since slots can be shaped in the direction of airflow, while holes are uniformly expanded. That is, for holes, the areas of the inlets and outlets undesirably increase as the length along the direction of airflow increases. Thus, slots can be configured to increase the amount of space available for fluid movement and heat transfer. Efficiency can be further improved by opening one end of a slot, for example, slots 20 and 40, to enhance movement of fluid through the slot. The angle of a slot with respect to airflow also is important. Lowering the angle of the slot with respect to a direction of airflow reduces the volume of the detached spaces associated with the slot. To enhance laminar airflow, a slot should have the smallest angle possible with respect to the direction of airflow. The angle of a slot also can be optimized to enhance centrifugal forces moving air in and out of the slot.

Although holes can produce turbulent airflow, their circular shape results in a very small interruption of the air stream and minimal formation of eddies, which are beneficial for heat transfer. Slots, particularly open slots, are the most effective way to introduce eddy and vortex characteristic turbulence in the air stream around a brake disc. In particular, open slots can introduce turbulent flow inside the slots and on the disc surface. For very small slot angles, with respect to the direction of airflow, an open slot is long and most of the heat loss is due only to laminar flow. The relatively small angle results in a long laminar flow, but minimal turbulence is generated. For high angle open slots, with respect to the direction of airflow, laminar heat transfer is reduced and turbulent heat transfer is increased. However, excessively high slot angles, with respect to the direction of airflow, may cause undesirable flow separation, which results in pockets of air having low velocity, that is, providing minimal heat removal, while causing significant drag.

Although disc 10 and slots 20 are used as examples in the following discussion, it should be understood that the discussion is not limited to disc 10 or slots 20 and is applicable to any present invention brake disc. There is an optimal slot width 28 associated with slots 20. Slot width 28 is dependent upon factors, such as the brake application, conditions associated with an application, material used in the disc, and slot parameters, such as slot angle and length. The optimum slot width 28 maximizes turbulent flow inside the open slots while minimizing the loss of disc surface areas due to the slots. In one embodiment, slot width 28 is less than thickness 26. This ratio of slot width 28 to thickness 26 increases the ratio of cooler surface layer volume to hotter bulk material volume. That is, the “loss” of surface area on the faces of disc 10 due to the formation of a slot is more than offset by the increased surface area associated with the surfaces of the slot.

FIG. 1A illustrates the radial direction R and the tangential direction T with respect to disc 10. The angles formed by slots 20, 30, and 40 on disc 10, or slot angles as described supra, can be measured with respect to a tangential direction or with respect to a radial direction. Unless noted otherwise, hereafter, angles are with respect to a radius of a respective disc. In FIG. 1A, the slot angle θ₁ is a radial measurement. For example, θ₁ is the angle formed between the length 31 of slot 30 and radius 42 of disc 10 passing through the slot. In general, θ₁ is more than zero degrees and less than 90 degrees. The radius is selected to intersect the approximate middle of a slot length, although other positions of the radius with respect to the slot are possible. As noted above, the characteristics of the airflow in a slot will depend on the angle θ₁. If the angle θ₁ is high, the slot will be more aligned with airflow across the disc, the airflow is more likely to be laminar. If the angle θ₁ is low, the airflow is more likely to be turbulent. In FIG. 1A, disc 10 is configured for a low speed application and angle θ₁ is approximately 45 degrees. It should be understood that the magnitude of angle θ₁ is shown for purposes of illustration only, and that other angles are possible for a low speed application. θ₁ is shown on a slot 30, however, it should be readily apparent to one skilled in the art that θ₁ is applicable to any slot in disc 10, for example, slots 20 and 40.

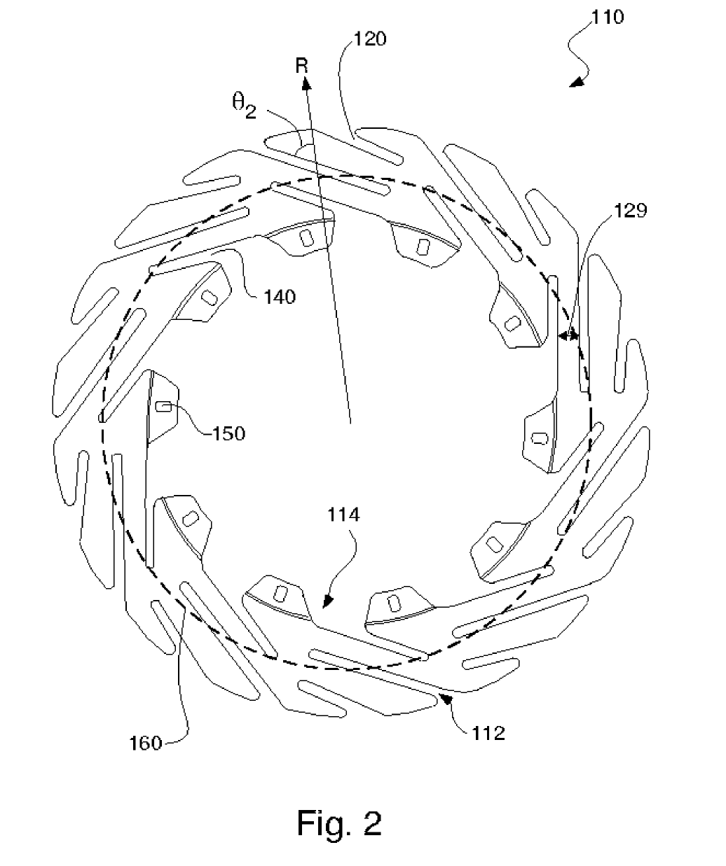

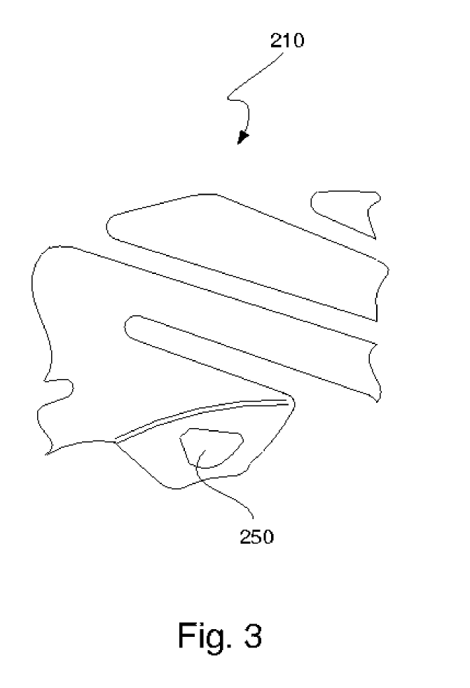

FIG. 2 is a front view of a present invention brake disc 110 having a plurality of slots arranged for high speed cooling in an OSP. Slots 120 and 140 make an angle θ₂ with the radial direction. Slots 120 extend to the outer perimeter 112. Slot 140 extends to the inner perimeter 114. Although closed slots, such as slots 30 in FIG. 1A, are not shown in FIG. 2, it should be understood that closed slots can be added to disc 110 and that such closed slots are within the spirit and scope of the invention as claimed. Disc 110 is attached to a brake assembly (not shown) by inserting fasteners (not shown) through mounting holes 150. It should be understood that FIG. 2 shows only one possible configuration of slots 120 and 140. Disc 110 can be fabricated to include only slots 120, only slots 140, or other combinations of slots 120 and 140. Since FIG. 2 is illustrating a high-speed application, the magnitude of angle θ₂ is greater than the magnitude of θ₁. It should be understood that the magnitude of angle θ₂ is shown for purposes of illustration only, and that other angles are possible for a high-speed application. Annulus 160, discussed further below, is located midway between the inner and outer perimeters.

The following should be viewed in light of FIGS. 1A and 2. Clearly the included angle of the open slot is a very important parameter. Therefore, there is an optimum angle that combines laminar and turbulent flow for which heat loss is maximized. For moderate angles, the flow across the slot is maintained, but due to geometric changes, turbulence is created inside and outside of the slot, increasing heat loss. It must be noted that the conditions indicated represent typical results only. Flow through a slot is very complicated and may be strongly dependent on the length/width ratio. Also, the optimum slot angle depends on the relative rotational speed and temperature. For high-speed applications, relatively higher radial angles are optimal, as the necessary cooling can be achieved with laminar flow cooling, as shown in FIG. 2. The resultant reduction in turbulence also leads to less drag and less power loss. For low-speed applications, laminar flow is insufficient for heat removal. Therefore, lower radial angles are optimal, as turbulent flow cooling is necessary to transfer the heat generated by such braking operations, as shown in FIG. 1A.

FIG. 3 is a partial front view of a wedge-shaped mounting hole 250 in a present invention brake disc 210. The following should be viewed in light of FIGS. 1A, 2, and 3. In FIGS. 1A and 2, mounting holes 50 and 150, respectively, have a shape that is well known in the art. In contrast, in FIG. 3, mounting hole 250 is in the shape of a wedged slot, similar to an isosceles triangle. During braking operations, most of the load is exerted on mounting holes in a brake disc by the mounting pins (not shown). The pins exert most of the forces on radially oriented surfaces. Typically, the fabricating process for a brake disc results in geometrical differences among the mounting holes, such as mounting holes 50 and 150, in the disc. As a result, the braking load is unevenly distributed among the mounting holes. Mounting hole 250 creates a more uniform distribution of the braking load among the mounting holes, by replacing the radial surface typical of earlier mounting holes, for example, holes 50 and 150, with two slanted surfaces. Thus, the effect of the fabrication differences is diminished, improving the distribution of the brake load among mounting holes, thereby reducing stress concentrations among the mounting holes and pins.

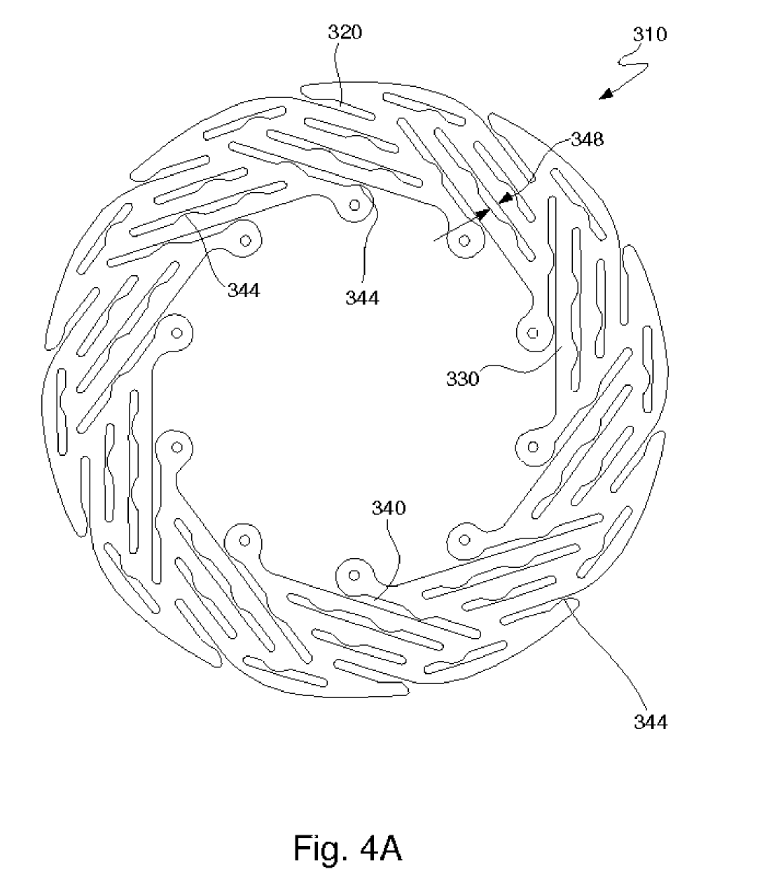

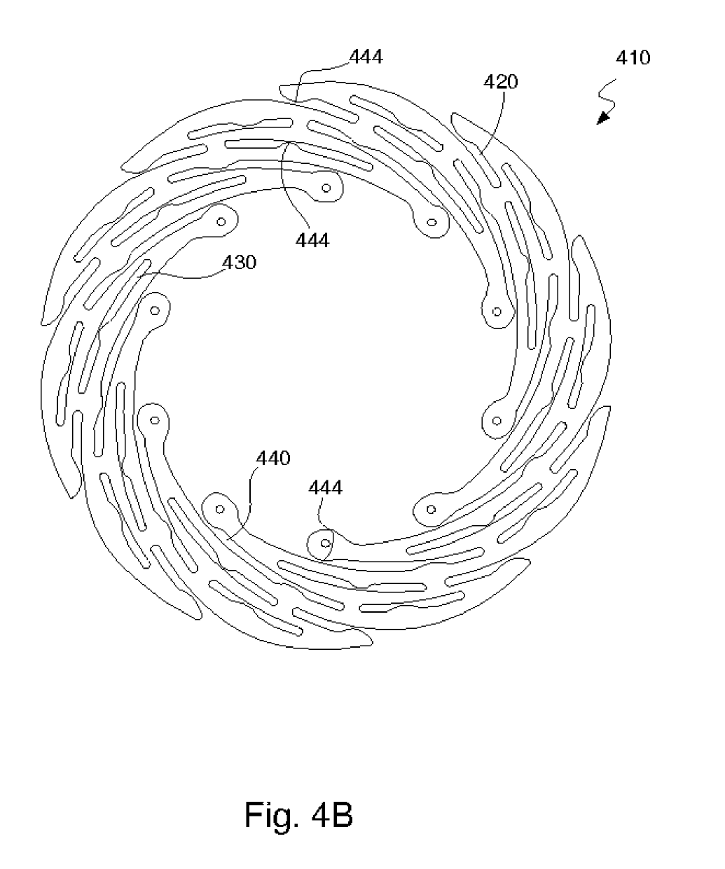

FIG. 4A is a partial front view of a present invention brake disc 310 with a plurality of slots arranged for low speed cooling in a HOSP and having protrusions to keep slots 320, 330, and 340 open.

FIG. 4B is a partial front view of a present invention brake disc 410 with a plurality of slots arranged for high speed cooling in a HOSP and having protrusions to keep slots 420, 430, and 440 open. The heat generated by braking operations causes the material of which discs 310 and 410 are constructed to expand. The following discussion references disc 310, however, it should be understood that the discussion applies equally to disc 410. Expansion of a disc can decrease the width of a slot, for example, width 348. Under more extreme braking conditions, slots 320, 330, or 340 can completely close. As the width of a slot decreases, the cooling capability of the slot also decreases. Thus, to prevent closing due to heat expansion, slots 320, 330, and 340 are fabricated with protrusions 344. Protrusions 344 are positioned to prevent slots 320, 330, and 340 from fully closing due to heat expansion, thus, improving the heat transfer characteristics of disc 310. As shown in FIGS. 4A and 4B, protrusions 344 and 444, respectively, can be located in a variety of positions along the length of a particular slot. However, it should be understood that the positions of protrusions 344 and 444 are not limited to those shown in FIGS. 4A and 4B. Rather, it should be understood that protrusions 344 and 444 can be located anywhere along the length of a slot. Further, it should be understood that the present invention is not limited to a particular number of protrusions in a slot or in a disc.

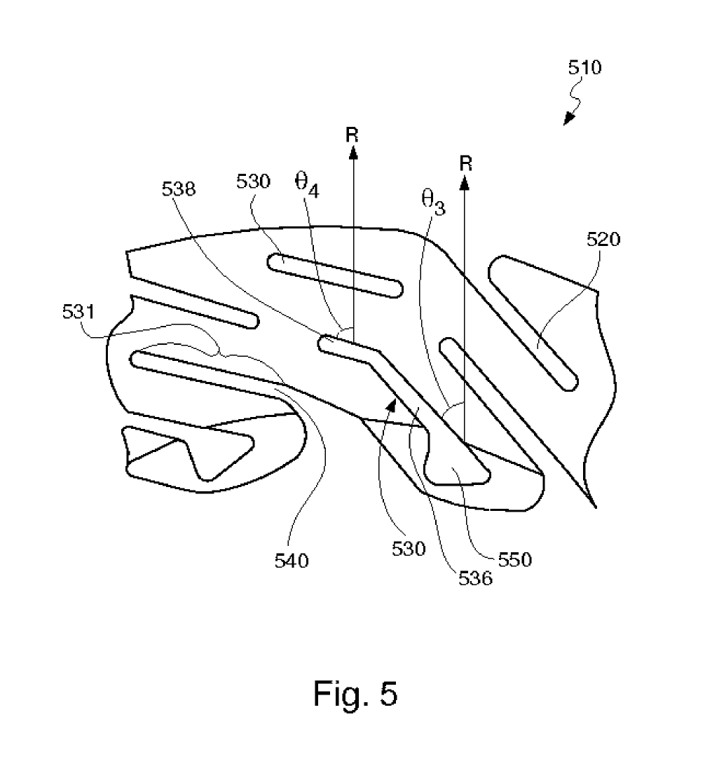

FIG. 5 is a partial front view of a present invention brake disc 510 with a curved slot 530. The following should be viewed in light of FIGS. 1A, 2, 3, 4A, 4B, and 5. The slots shown in FIGS. 1A, 2, 3, 4A, 4B, and 5 have a length, for example, length 31 in FIG. 1A or length 531 in FIG. 5. The lengths in FIGS. 1A, 2, 3, and 4A are substantially straight when measured with respect to a plane orthogonal to axis 22, for example surfaces 24 and 25. However, the slots in FIG. 4B and slots 530 in FIG. 5 have a curved, or arcuate, shape. In general, a curved slot can be in the shape of a smooth or continuous curve, as shown in FIG. 4B, a segmented shape (i.e., a series of straight segments), as shown in FIG. 5, or a combination of smooth and segmented shapes (not shown). In FIG. 5, curved slot 530 is segmented in shape and includes first portion 536 and second portion 538. It also should be understood that slot 530 can include more than two segments (not shown). First portion 536 is in communication with wedge-shaped mounting hole 550. It should be understood that the present invention is not limited to the arcuate shapes shown in FIGS. 4B and 5 and that other arcuate shapes are included within the spirit and scope of the invention as claimed. It should be readily apparent to one skilled in the art that combinations of curved and straight slots beyond those shown in FIGS. 4B and 5 are possible, and such combinations are within the spirit and scope of the invention as claimed.

Changing the radial angle of portions 536 and 538 or any of slots 420, 430, or 440 can change the ratio of laminar to turbulent airflow through and around the respective slot. In FIG. 5, the radial angle θ₃ of portion 536 is less than the radial angle θ₄ of portion 538. However, it should be understood that portion 536 can be configured such that radial angle θ₃ is greater than the radial angle θ₄ (not shown). It also should be understood that for those embodiments in which slot 530 has more than two segments (not shown), the segments can be configured to have radial angles in any combination of increasing or deceasing values. For example, for a sequence of segments, consecutive radial angles could increase or decrease, or respective segment radial angles could alternately increase and decrease.

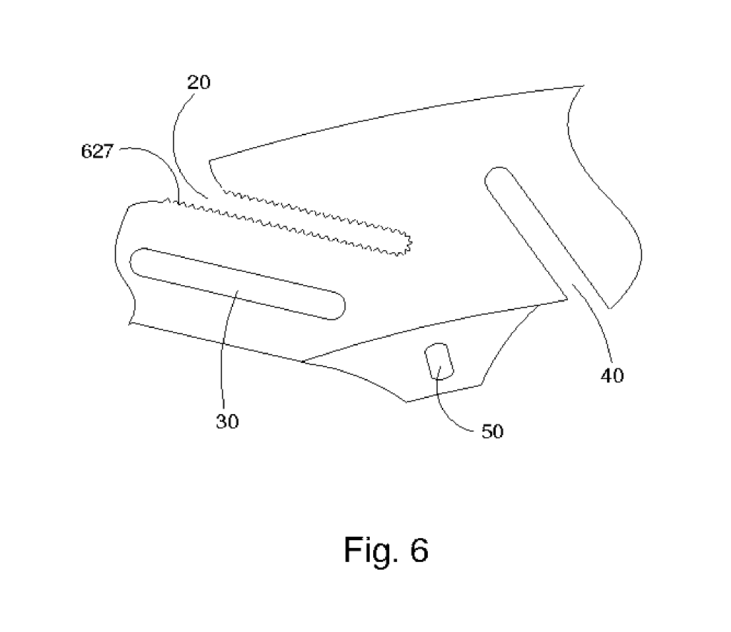

FIG. 6 is a partial plan view of a slot 20, from FIG. 1A. The following should be viewed in light of FIGS. 1A, 1B, and 6. In FIG. 6, slot surface 627 is rough. Rough surface 627 trips the boundary layer to turbulence at a lower air speed, producing secondary turbulence in slot 20. This secondary turbulence enhances the turbulent cooling of disc 10. It should be understood that the above discussion is applicable to any slot in a present invention brake disc, for example, slots 30 and 40 in FIG. 1A and the slots shown in FIGS. 2, 4A, and 4B. Slot surface 627 is shown with a series of grooves oriented in the general direction of axis 22. However, it should be readily apparent to one skilled in the art that other shapes and configurations are possible for surface 627, and such modifications are within the spirit and scope of the invention as claimed.

The following should be viewed in light of FIGS. 1A through 6. The slots of the present invention enhance the cooling rate of a brake disc or rotor made according to the present invention. The present invention OSP and HOSP in a brake disc help reduce hoop and radial stresses on the brake disc. Hoop stresses are due to tensile and compressive circumferential stresses associated with the unequal heating and cooling of external circumferential surfaces and the center of an area swept by a brake pad. Hoop stress occurs because the outer edge of a disc moves faster than the inner edge, causing the outer edge to cool more quickly. As a result, the outer perimeter contracts while the inner perimeter is still expanding due to the inner perimeter's higher temperature. The slots of the present invention can be arranged to break all the concentric planes of the disc, dissipating the hoop stresses. By eliminating the hoop stresses, the present invention eliminates heat cracks that form on the inner and outer perimeter due to the uneven cooling of a conventional disc or rotor. However, this combination does not diminish the radial stresses, or thermal heat cracks. Heat cracks are formed during excessive internal deformation where the borders also reach high temperatures. The present invention addresses radial stresses by selecting a geometrical distribution of open slots that absorb the differences in deformation between the near-border regions and flanked-by-border regions, thereby eliminating the internal tensile and compressive hoop stresses.

The borders of a brake disc are responsible for part of the heat loss during the braking. Therefore, the borders remain cooler and have a greater strength than the bulk of the disc. The differences in strengths bring about a differential deformation between the center of the disc and the borders of the disc. The differential deformation can produce plastic deformation, which, in turn, can result in warping of the disc. Typically, for a brake disc, the deformation is not uniform and the material is pushed outward following a radial pattern. While the distance between the borders increases, the dimension of the external and internal borders remains the same. Therefore, the only possible geometrical solution is to change the plane of the outer border with respect of the inner border. Thus, the disc deforms, taking the shape of a cup or dish. To avoid this effect, it is necessary to cut the borders. This can be accomplished by suitably sized and positioned open slots. To minimize potential deformation, the open slots should cut as many concentric lines as possible. Therefore, as shown in FIG. 2, for example, for embodiments with slots opening to both the inner and outer perimeters of the disc, the respective slots reach at least the middle area of the disc, that is, annulus 160.

The present invention also takes into consideration the flexing of a slot in a closing mode. As a result stresses at the closed end of slots are mostly compressive, lowering the risk of crack formation/propagation. To reduce shear modes and boost tensile stresses, the present invention takes into account the deformation modes. As a result, most of the material beside the slots is under large tensile stresses and minimum shear.

The temperatures generated by braking soften most of the materials comprising a disc brake. However, at the slots, a cooler slot surface layer is created. Therefore, the slot surfaces form harder layers of materials at high temperatures. As a result, hot deformation of the disc is reduced and the overall strength of the disc material is increased. Also OSPs and HOSPs are capable of forming additional cooling surfaces well into the central parts of a disc. The resulting hard open slot surface layers withhold the deformation of the soft layers of bulk material of the disc/rotor.

In some embodiments, the slots in an OSP or HOSP are arranged in a pattern. In some aspects, for example, as shown in FIGS. 1A and 2, those patterns are homogeneous, that is, slots within the pattern are uniformly distributed. Uniform distribution of slots results in a significant improvement in the hot plastic response of the disc. To keep a maximum amount of disc material at a minimum temperature, and to optimize temperature-strength related improvements, the distances between slots, for example, distance 29 in FIG. 1A and distance 129 in FIG. 2, can be less than twice the thickness of the rotor, for example, thickness 26 in FIG. 1B.

In some embodiments, present invention discs are solid annular discs. In some embodiments, present invention discs are vaned annular discs.

Present invention slots also can be oriented within a brake disc to minimize pad wear. Present invention open slots help cause wiping of the disc surfaces, for example, surfaces 24 and 25 in FIG. 1B, thereby removing the debris generated by the brake operation. The wiping actions of the open slots also remove water, dust, and external debris. These cleaning actions improve the performance of the discs/rotors. The present invention OSP and HOSP have the additional advantage of reducing the overall weight of the disc, which in turn reduces the rotational inertia of the brake system. This accounts for a reduction in power requirements to accelerate the vehicle (lower inertia).

The rotors or discs of the present invention may be fabricated by using a water jet, a laser cutter, milling, or any other method known in the art. The rotors and discs may also be made using consolidation techniques such as powder metallurgical, casting, forging, or any other means known in the art. The discs and rotors may be made of cast iron, steel, ceramic, plastic, composite, or any other material known in the art.

The advantages of the present invention are illustrated by the following examples.

Example 1: a comparison test of a solid disc and a disc with a pattern of holes was performed. The cooling rates were practically undistinguished. This result supports the observation that a detached space is formed at a hole due to the sudden change in the surface morphology and this detached space fills the entire hole, making air movement and heat dissipation very difficult. Thus, holes generate virtually no cooling effects. In general, holes reduce the weight of the disc/rotor and may reduce some of the hoop stresses. However, either cupping or operating temperatures were not reduced by the introduction of holes.

Example 2: during additional tests, the cooling rates/heat transfer of rotors with closed-slots, were shown to be lower than those generated by those rotors with OSPs or HOSPs. Also, the operating temperatures of rotors/discs with closed slot patterns were above the operating temperatures of the OSP and HOSP discs.

Example 3: in general, the low tangential angle (high radial angle) open slot pattern shows an initial braking power higher than the high tangential angle (low radial angle) open slot pattern. Higher initial braking power improves the ability of the driver to control the braking process.

Example 4: cast-iron-vaned rotors with and without OSPs were tested for durability and fatigue life. The OSP rotors show an increase in durability or life (more than 200%). It is important to emphasize that the advantage introduced by the OSP on the vaned rotors are restricted by the vanes themselves. The effects of the OSP are more prominent if the testing is performed on single discs. For cast-iron single-disc brake rotors, the OSP increased the rotor life by 300%.

Thus, it is seen that the objects of the present invention are efficiently obtained, although modifications and changes to the invention should be readily apparent to those having ordinary skill in the art, and these modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

1. A brake apparatus with improved heat transfer properties, comprising:
an annular disc; and,
at least one slot in said disc arranged at an angle greater than zero degrees and less than ninety degrees with respect to a radius of said disc passing through said slot.

2. The brake apparatus as recited in claim 1 wherein said annular disc further comprises a longitudinal axis and first and second face surfaces disposed substantially orthogonal to said longitudinal axis; and,
wherein said at least one slot further comprises a slot surface at least partially bounded by said first and second face surfaces.

3. The brake apparatus as recited in claim 2 wherein said at least one slot further comprises a protrusion disposed on said slot surface.

4. The brake apparatus as recited in claim 3 wherein said at least one slot has a length and a midpoint of said length and said protrusion is disposed proximate said midpoint.

5. The brake apparatus as recited in claim 2 wherein said annular disc further comprises an outer perimeter; and,
wherein said at least one slot is in communication with said outer perimeter.

6. The brake apparatus as recited in claim 5 wherein said at least one slot further comprises a protrusion disposed on said slot surface.

7. The brake apparatus as recited in claim 6 wherein said at least one protrusion is disposed proximate said outer perimeter.

8. The brake apparatus as recited in claim 2 wherein said disc further comprises an inner perimeter; and,
wherein said at least one slot is in communication with said inner perimeter.

9. The brake apparatus as recited in claim 8 wherein said at least one slot further comprises a protrusion disposed on said slot surface.

10. The brake apparatus as recited in claim 9 wherein said protrusion is disposed proximate said inner perimeter.

11. The brake apparatus as recited in claim 2 wherein said slot surface is substantially rough in texture.

12. The brake apparatus as recited in claim 2 wherein said at least one slot has a length in a straight shape with respect to a plane orthogonal to said longitudinal axis.

13. The brake apparatus as recited in claim 2 wherein said at least one slot has a length in an arcuate shape with respect to a plane orthogonal to said longitudinal axis.

14. The brake apparatus as recited in claim 2 wherein said at least one slot has a length in a shape, with respect to a plane orthogonal to said longitudinal axis, comprising a combination of straight and arcuate segments.

15. The brake apparatus as recited in claim 2 wherein said annular disc has a thickness measured between said first and second face surfaces; and,
wherein said at least one slot further comprises a first plurality of slots disposed so that each slot in said first plurality of slots is separated from an adjacent slot in said first plurality of slots by a distance, measured along said first surface, less than twice said thickness.

16. The brake apparatus as recited in claim 2 wherein said annular disc has a thickness measured with respect to said first and second face surfaces; and,
wherein said at least one slot further comprises a width, measured with respect to said first surface, less than said thickness.

17. The brake apparatus as recited in claim 2 wherein said annular disc further comprises an outer perimeter and an inner perimeter; and,
wherein said at least one slot further comprises a first slot in communication with said outer perimeter and a second slot in communication with said inner perimeter.

18. The brake apparatus as recited in claim 17 wherein said annular disc further comprises an annulus disposed midway between said inner and outer perimeters; and,
wherein said first and second slots intersect said annulus.

19. The brake apparatus as recited in claim 1 wherein said at least one slot further comprises a second plurality of slots disposed in a specified pattern.

20. The brake apparatus as recited in claim 19 wherein said specified pattern is a homogeneous pattern.

21. The brake apparatus as recited in claim 1 wherein said annular disc is selected from the group including solid annular discs and vaned annular discs.

22. The brake apparatus as recited in claim 1 wherein said annular disc further comprises an inner perimeter; and,
wherein said slot includes a closed end disposed proximate said inner perimeter, configured in a triangular shape, and operatively arranged as a mounting hole for said annular disc.

23. A method for making a brake apparatus with improved heat transfer properties, comprising:
creating an annular disc; and,
forming in said disc at least one slot arranged at an angle greater than zero degrees and less than ninety degrees with respect to a radius of said disc passing through said slot.

24. The method recited in claim 23 wherein said annular disc further comprises a longitudinal axis;
wherein said creation further comprises forming said disc with first and second face surfaces substantially orthogonal to said longitudinal axis; and,
wherein said formation further comprises forming said at least one slot with a slot surface at least partially bounded by said first and second face surfaces.

25. The method recited in claim 24 wherein said formation further comprises forming a protrusion disposed on said slot surface.

26. The method recited in claim 25 wherein said formation further comprises forming said at least one slot with a length and a midpoint of said length and disposing said protrusion proximate said midpoint.

27. The method recited in claim 24 wherein said annular disc further comprises an outer perimeter; and,
wherein said formation further comprises connecting said at least one slot with said outer perimeter.

28. The method recited in claim 27 wherein said formation further comprises forming a protrusion disposed on said slot surface.

29. The method recited in claim 28 wherein said formation further comprises disposing said protrusion proximate said outer perimeter.

30. The method recited in claim 24 wherein said annular disc further comprises an inner perimeter; and,
wherein said formation further comprises connecting said at least one slot with said inner perimeter.

31. The method recited in claim 30 wherein said formation further comprises forming a protrusion disposed on said slot surface.

32. The method recited in claim 31 wherein said formation further comprises disposing said protrusion proximate said inner perimeter.

33. The method recited in claim 24 wherein said formation further comprises forming said slot surface with a substantially rough texture.

34. The method recited in claim 24 wherein said formation further comprises forming said at least one slot with a length having a straight shape with respect to a plane orthogonal to said longitudinal axis.

35. The method recited in claim 24 wherein said formation further comprises forming said at least one slot with a length having an arcuate shape with respect to a plane orthogonal to said longitudinal axis.

36. The method recited in claim 24 wherein said formation further comprises forming said at least one slot having a length with a shape, with respect to a plane orthogonal to said longitudinal axis, comprising a combination of straight and arcuate elements.

37. The method recited in claim 24 wherein said annular disc further comprises a thickness measured between said first and second face surfaces; and,
wherein said formation further comprises forming a first plurality of slots disposed so that each slot in said first plurality of slots is separated from an adjacent slot in said first plurality of slots by a distance, measured with respect to said first surface, less than twice said thickness.

38. The method recited in claim 24 wherein said annular disc further comprises a thickness measured between said first and second face surfaces; and,
wherein said formation further comprises forming said at least one slot with a width, measured with respect to said first surface, less than said thickness.

39. The method recited in claim 23 wherein said annular disc further comprises an outer perimeter and an inner perimeter; and,
wherein said formation further comprises forming a first slot extending to said outer perimeter and a second slot extending to said inner perimeter.

40. The method recited in claim 39 wherein said annular disc further comprises an annulus disposed midway between said inner and outer perimeters; and,
wherein said formation further comprises disposing said first and second slots to each intersect said annulus.

41. The method recited in claim 23 wherein said formation further comprises disposing a second plurality of slots in a specified pattern.

42. The method recited in claim 41 wherein said disposal further comprises disposing said second plurality of slots in a homogeneous pattern.

43. The method recited in claim 23 wherein said creation further comprises creating said annular disc selected from the group including solid annular discs and vaned annular discs.

44. The method recited in claim 23 wherein said annular disc further comprises an inner perimeter; and,
wherein said formation further comprises forming said at least one slot with a closed end disposed proximate said inner perimeter, configuring in a triangular shape, and operatively arranging as a mounting hole for said annular disc.
